(19) United States
(12) Patent Application Publication
(10) Pub. No.: US 2019/0244236 A1
(43) Pub. Date: Aug. 8, 2019

(54) SYSTEM AND METHOD FOR AUTOMATED ENROLLMENT

(71) Applicants: Yudong Xu, Singapore (SG); Prudhvi Vatsavai, Singapore (SG)

(72) Inventors: Yudong Xu, Singapore (SG); Prudhvi Vatsavai, Singapore (SG)

(21) Appl. No.: 15/892,235

(22) Filed: Feb. 8, 2018

(51) Int. Cl. G06Q 30/02

(52) U.S. Cl. CPC G06Q 30/0226

(57) ABSTRACT

The system may select the bulk electronic transaction data for a card acceptor identification signal (CAID), select the bulk electronic transaction data for an acquirer business identification number (BIN), analyze the selected CAID and BIN to determine if the CAID and BIN belong to a registered merchant. If the CAID and BIN belong to a registered merchant, the electronic transaction data may be communicated to an offers platform where the transaction may be analyze to determine if the transaction meets an offer. In response to the transaction meeting an offer, the system may execute the offer by creating modified transaction data to reflect the offer.

### BACKGROUND

Encouraging consumers to join an electronic loyalty program is becoming increasingly challenging, even when the enrollment may benefit the consumer. Consumers are hesitant to provide personally identifiable information as they fear it may be stolen and used for nefarious purposes. In addition, there has been an explosion of electronic loyalty and promotion programs which simply may become overwhelming to most consumers. It may be hassle or annoyance to provide personal information repeatedly to every merchant or even every merchant location a consumer may use. At the same time, benefits are available to consumers that do join electronic loyalty and promotion users and these benefits may be missed if the consumers do not enroll in the electronic loyalty and promotion programs.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

The present disclosure provides a technical solution to the technical problem of he described system and method allows for consumers to receive the benefits of electronic loyalty or promotion systems without enrolling in the systems. The system may analyze bulk electronic transaction data to determine if the transaction is a transaction from a registered merchant in the response program. In one embodiment, the system may select the bulk electronic transaction data for a card acceptor identification signal (CAID), select the bulk electronic transaction data for an acquirer business identification number (BIN), analyze the selected CAID and BIN to determine if the CAID and BIN belong to a registered merchant. If the CAID and BIN belong to a registered merchant, the electronic transaction data may be communicated to an offers platform where the transaction may be analyze to determine if the transaction meets an offer. In response to the transaction meeting an offer, the system may execute the offer by creating modified transaction data to reflect the offer and may communicate the modified transaction data to at least one of the payment system, the user; and the registered merchant.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the parties in the system;

FIG. 2 is an illustration of a plow chart of directions used to physically configure a processor

FIG. 3 is an illustration of a sample user interface to create a response;

FIG. 4 is an illustration of some of the computing aspects of the system; and

FIG. 5 is an illustration of a sample computer which may be adapted to be part of the system.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### Specification

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, components, or devices. Accordingly, the present invention may take the form of an entirely hardware embodiment, an entirely software embodiment, or an embodiment combining software and hardware aspects. The following detailed description is, therefore, not to be taken in a limiting sense.

Encouraging consumers to join an electronic loyalty program is becoming increasingly challenging, even when the enrollment may benefit the consumer. Consumers are hesitant to provide personally identifiable information as they fear it may be stolen and used for nefarious purposes. In addition, there has been an explosion of electronic loyalty and promotion programs which simply may become overwhelming to most consumers. It may be hassle or annoyance to provide personal information repeatedly to every merchant or even every merchant location a consumer may use. At the same time, benefits are available to consumers that do join electronic loyalty and promotion users and these benefits may be missed if the consumers do not enroll in the electronic loyalty and promotion programs.

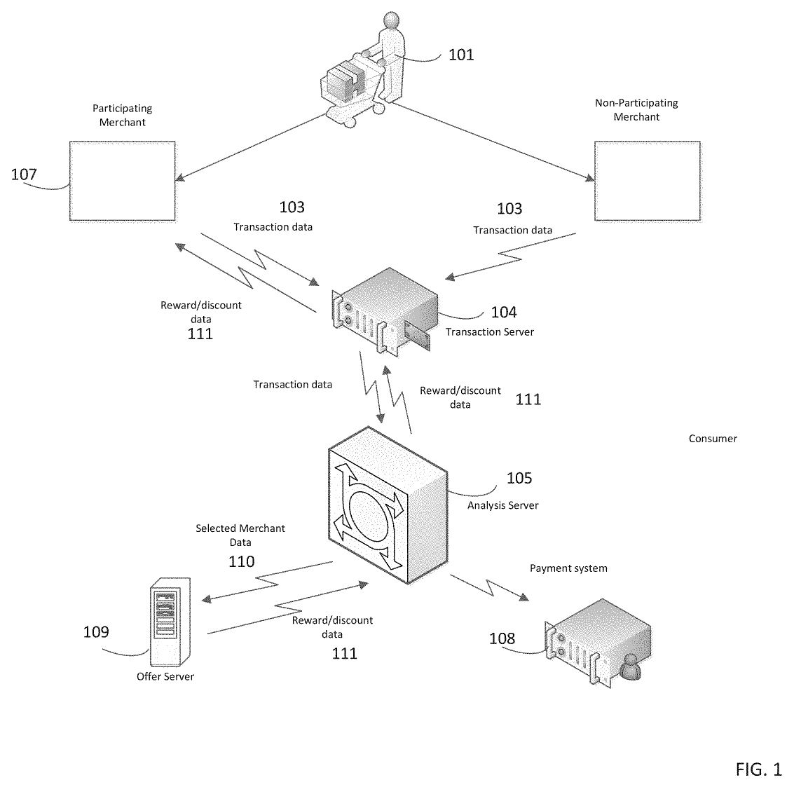

In the disclosed system and method, the consumer may receive the benefits of a loyalty or rewards program without formally enrolling in the loyalty or reward program. Referring to FIG. 1, at a high level, all transactions 103 in an analysis server 105 and may be reviewed and transactions that represent a participating merchant 107 may be selected for further review to reduce the enormous burden of reviewing every single transaction in depth. The selected transactions 109 may be further analyzed to determine if a desired merchant or merchant location is part of the transaction. From there, the substance of the transaction may be reviewed to determine if a reward or bonus condition has been met by an offer server 111. If the bonus or reward condition has been met, the bonus or reward 111 may be applied and communicated to the merchant and to the consumer.

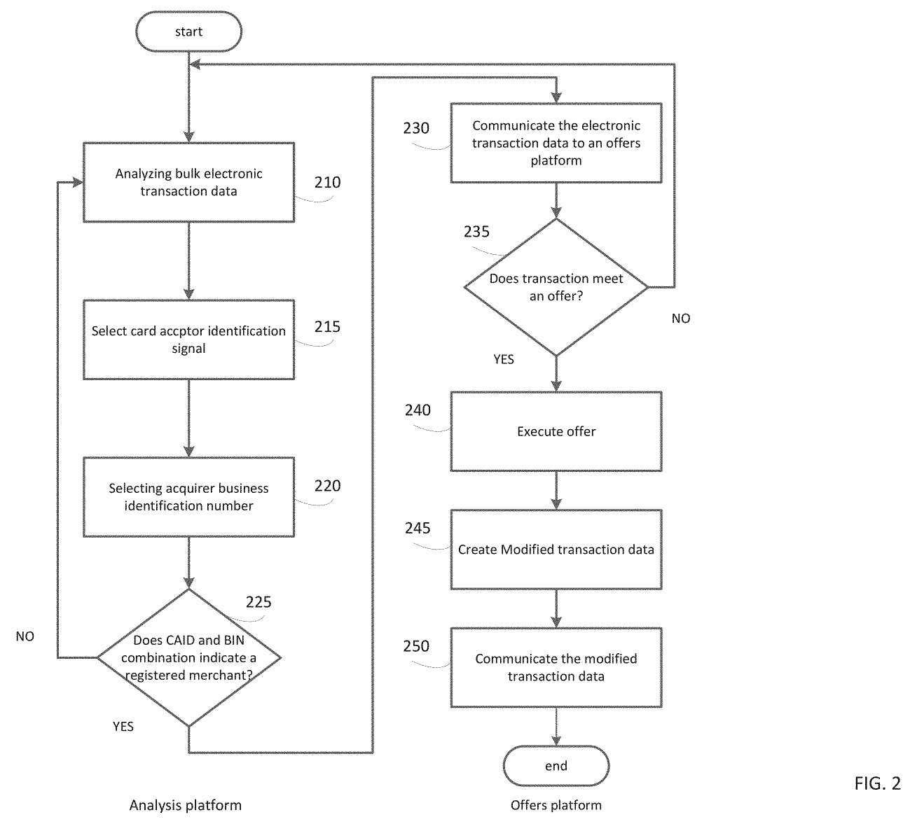

More specifically, FIG. 2 discloses a method of enrolling an electronic transaction user 101 in an electronic response program 100 without enrollment action by the user. As mentioned previously, electronic consumers 101 may be exhausted and leery of repeatedly registering for electronic response programs. The disclosed system 100 may allow consumers 101 to receive the benefits of an electronic response program 100 without formally enrolling in the program.

An electronic transaction may be a purchase of a good or service from a merchant 107. The electronic transaction data 103 may be created using an account that represents value, such as a credit card account, a debit card account, a savings account, a frequent flier account or any other currency that may be electronically exchanged. Logically, the electronic account transaction data 103 may be communicated through a network such that the transaction may be reviewed to determine if an electronic response is appropriate.

An electronic response program 109 may be a loyalty or coupon type program that operates on an electronic payment platform 100. In the past, users had coupons or stamp to indicate a response such as a discount was appropriate. In the electronic transaction environment, the electronic response program 109 may provide a discount, a rebate, a free item, an increase in status such as moving from a base status to a higher status, etc. The program may be electronic in that it may review electronic transactions and may provide the response electronically.

The concept of enrollment action may usually include traditional enrollment actions such as filling out a form and submitting it to an authority or filling out an electronic form on a web site or the like or in a mobile application. The data is stored and usually an identifier is assigned to the consumer such that reward may be tracked and awarded. The consumer often has to recall the identifier and a password to check on the status of a reward. In some situations, a consumer is given a physical card to remind them of the identifier and password.

At block 210, bulk electronic transaction data 103 (FIG. 1) from a transaction server 104 may be analyzed at an analysis server 105 to determine if the transaction is a transaction from a registered merchant in the response program. A registered merchant 107 may take on a variety of forms. In one embodiment, the registered merchant 107 may be a single registered merchant sales location. In another embodiment, the registered merchant 107 may be an entire chain of stores that belong to a merchant parent. In yet another embodiment, the registered merchant 107 may be a plurality of merchants in a location such as a county or a state or a region.

Logically, each electronic transaction may create a communication of transaction data 103 between a merchant 107 and a payment network which may include an issuing bank, an interchange and an acquiring bank. Electronic transaction data 103 may carry a variety of elements. The elements may follow a standard such as PCI DSS (Payment Card Industry Data Security Standard).

Further, due to the number of transactions, the amount of data that is in bulk electronic transactions 103 may be overwhelming. Trying to review all the details of every transaction would be a technical problem in that the sheer volume of data would be impossible to review to identify the few that may be of interest. The described system and method reviews just some of the select data 109 to create a subset to be reviewed more closely. By selecting the transactions for registered merchants 107, the amount of data that needs to be reviewed in detail will be significantly reduced.

At block 215, the card acceptor identification signal (CAID) may be selected from the bulk electronic transaction data 103. The CAID may be part of the transaction data 103 and may be selected to assist the more detailed review to determine whether the card acceptor is part of the offer. The CAID may follow a known protocol and only a portion of the CAID may need to be reviewed to determine if further analysis is required. For example, the CAID may have sixteen bits but only eight may be needed to establish if the card acceptor is relevant.

At block 220, an acquirer business identification number (BIN) may be selected from the bulk electronic transaction data 103. The BIN may be part of the transaction data 103 and may be selected to assist in limiting the more detailed review to merchants 107 that are part of the offer. The BIN may follow a known protocol and only a portion of the BIN may need to be reviewed to determine if further analysis is required. For example, the BIN may have sixteen bits and only eight may need to be reviewed to establish if the card acceptor is relevant.

At block 225, the selected CAID and BIN may be analyzed in the analysis server 105 to determine if the CAID and BIN belong to a registered merchant 107. The combination of the CAID and BIN may be used to pinpoint whether a merchant is a registered merchant 107. The combination may be to a single merchant location or to a chain of merchants or to merchants in another desired grouping such as the west coast or in the European Union.

In some embodiments, the CAID and BIN combination is compare to a lookup table to determine if they indicate a registered merchant 107. In other embodiments, the CAID and BIN may be communicated to a separate server using an API and the separate server may respond with a positive signal or a negative signal. The communication may follow a predetermined protocol and may be communication using an application programming interface (API) to the remote server where the communicated data may be in an expected form and the response may also be in an expected format or protocol such as a simple “1” to indicate a positive result and a “0” to indicate a negative result.

At block 230, in response to the CAID and BIN being determined to belong to a registered merchant 107, the selected electronic transaction data 110 may be communicated to an offers platform or server 109. An offers platform 109 may operate on a separate sever that may be created specifically to handle electronic offers. In some embodiments, the offers platform 109 may operate according to an offers platform API and the offers platform API may follow an offers platform protocol. In this way, data in a known format may be communicated to the offer platform where it may be analyzed and a response offer may be generated and communicated back to the payment system.

At block 235 in the offers platform 109, the transaction data 110 indicated by the selected CAID and BIN (a registered merchant) may be analyzed to determining if the transaction meets an offer. For example, if any offer is for a discount on tires, the transaction data 110 may be reviewed to determine if tires were purchased. More specifically, analyzing the transaction may include comparing parameters of the transaction to a set of offer rules. As a further example, the discount may only apply to tires of type Zero and the parameters may indicate whether the tires were of type Zero.

At block 240, in response to the transaction meeting or satisfying an offer, the offer or response may be executed. Logically, the response or offer 111 may take on a variety of forms. In some embodiments, the response or offer 111 may be a discount. In another embodiment, the response or offer 111 may be an offer of bonus points. In yet another embodiment, the response or offer 111 may be a specific amount reduction. In yet another embodiment, the response or offer 111 may be a free item. In yet another embodiment, the response or offer 111 may be an increment closer to an additional response. Of course, other types of response or offer 111 are possible and are contemplated.

In some embodiments, the purchase may qualify for a plurality of response or offers 111. In one embodiment, the response or offer 111 with the highest value may be applied. In another embodiment, the user may create a hierarchy of how the response or offer 111 should be applied. The hierarchy may be on a merchant by merchant basis or on a good by good basis or a service by service basis.

In yet another embodiment, the various response or offers 111 that apply may be communicated to the user and the user may be able to select an response or offer 111 to be applied. In some embodiments, the communication may be directed toward a portable computing device 104 that is associated with the user such as to a smart phone 104 associated with the user. In another embodiment, the communication may be toward a point-of-sale device 106 at the merchant and the user may be able to select the offer using the point of sale device 106.

At block 245, modified transaction data may be created to reflect the offer. The manner of modifying the transaction data logically may depend on the type of offer. For example, if the offer was a discount, the amount of the transaction may be reduced. In some embodiments, the discount may be noted with an additional entry in the transaction record such that the user will be reminded of the benefit of the offer.

At block 250, the modified transaction data 111 may be communicated to one or more members of the payment network such as the payment system, the user 101 or the registered merchant. 107 As a result, the relevant parties to the offer will be informed of the application of the response or offer 111 and will be able to track the results of the offer.

In another aspect, FIG R may illustrate a user interface 310 that may be presented to a merchant which may allow the merchant to set up response parameters. Response parameters may be parameters that make sure the offer stays within bounds that are acceptable to the offeror. Parameters may include a time period for the response 320, a compensation maximum for the response and a number of repeat responses, what it takes to qualify 330 or what is the offer or response 340. The user interface 310 may be designed to make it easy for merchants to set up, track, maintain and end response promotions.

The user interface 310 may have a plurality of embodiments. In the past, creating offers was a challenge as the offer user interface looked like a programming interfaces. Trying to define conditions that need to be met in order to grant a response have been confusing with programming terms like greater than or less than or equal to. In one proposed embodiment, the usual programming type interface is replaces with images or emoji type images which will make the creation of the promotional campaign easier.

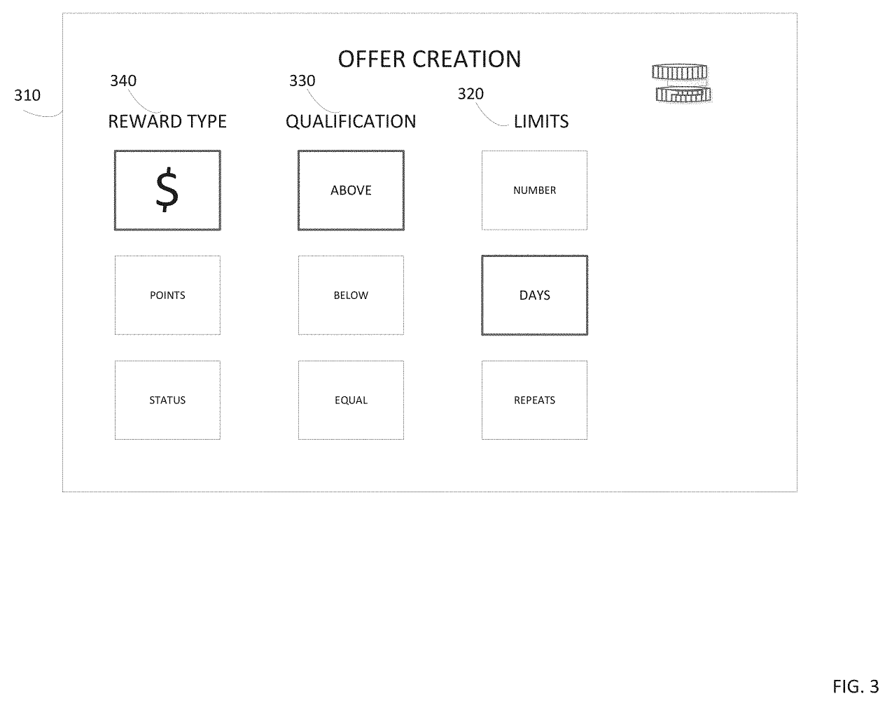

For example, referring to FIG. 3, the possible responses may be indicated using visual indications such as a dollar image, a present box or a rising account indicator. Limits on the response may be created using movable bars or sliders. Further the various limits may be indicated by illustrations. Finally, the results of the promotion may also be illustrated in a graphical manner where progress toward a sales goal or progress toward a limit may be indicated.

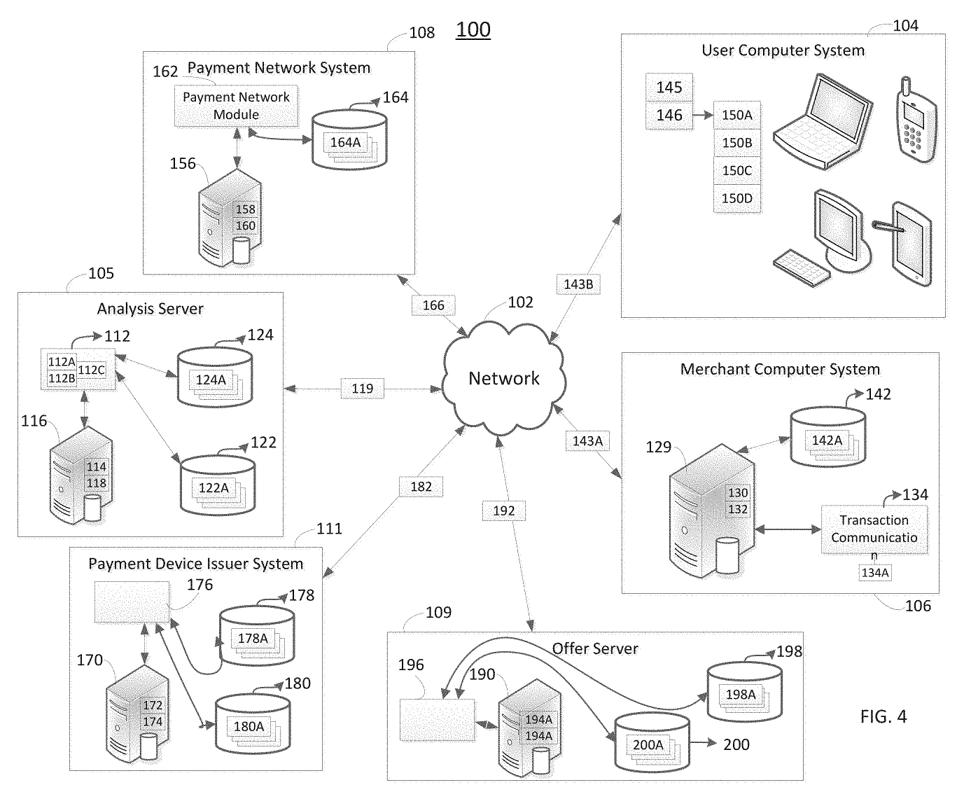

FIG. 4 generally illustrates one embodiment of a payment system 100 for completing transactions such as payments and other funds transfers including an analysis server 105 and an offer server 109 which may enroll a user in offers with no action on behalf of the user. The system 100 may include a computer network 102 that links one or more systems and computer components. In some embodiments, the system 100 includes a user computer system 104, a merchant computer system 106, a payment network system 108, an analysis server 105, and a payment device issuer system 111. The system 100 for enrolling an electronic transaction user in an electronic response program without action by the user may include a plurality of servers that are specially design and built to perform a specific task.

The network 102 may be described variously as a communication link, computer network, internet connection, etc. The system 100 may include various software or computer-executable instructions or components stored on tangible memories and specialized hardware components or modules that employ the software and instructions to quick review transactions by monitoring communications between users and merchants as well as other parties in a “Four Party Transaction Model.”

The various modules may be implemented as computer-readable storage memories containing computer-readable instructions (i.e., software) for execution by one or more processors of the system 100 within a specialized or unique computing device. The modules may perform the various tasks, methods, modules, etc., as described herein. The system 100 may also include both hardware and software applications, as well as various data communications channels for communicating data between the various specialized and unique hardware and software components.

The analysis system 105 may include one or more instruction modules including a module 112 that, generally, may include instructions to cause a processor 114 of the analysis server 116 to functionally communicate with a plurality of other computer-executable steps or sub-modules, e.g., sub-modules 112A, 112B, 112C, and components of the system 100 via the network 102. These modules 112A, 112B, 112C may include instructions that, upon loading into the server memory 118 and execution by one or more computer processors 114, determine whether a merchant is a participating merchant 107 by reviewing the CAID and BIN combination. For example, sub-modules may include a first machine learning module 112A, a second machine learning module 112B, a data integration module 112C, etc. A first data repository 122 may store merchant participation data 122A for entities of the system 100. In some embodiments, further data repositories may correspond to different types of transaction data 122A or sub-components of the transaction data 122A (e.g., a transaction region, transaction type, a time of day, a merchant and/or customer type, a payment device type, a transaction clearing delay, transaction amount, cardholder name, cardholder account number, and other payment network account data 164A, etc.). Various other data 124A may be received and/or derived by the analysis system 105 and stored in a second data repository 124 and used by the system 100 as described herein. For example, the second data repository may be used to store electronic wallet transaction details 124A from an electronic wallet system or other method of electronic or computer-based payment.

An analysis server 105 may be used for analyzing bulk electronic transaction data to determine if the transaction is a transaction from a registered merchant in the response program. As a result of the phenomenal amount of electronic transaction data, the server may have a large io buffer, one or more high speed processors and limited graphics capabilities as the server is more for analysis than creating graphical representations.

The analysis server 105 may be designed for selecting the bulk electronic transaction 103 data for a card acceptor identification signal (CAID), selecting the bulk electronic transaction data 103 for an acquirer business identification number (BIN), analyzing the selected CAID and BIN to determine if the CAID and BIN belong to a registered merchant 107, and in response to the CAID and BIN being determined to belong to a registered merchant, communicating 119 the electronic transaction data 110 to an offers platform 109 on an offer server.

The merchant computer system 106 may include a computing device such as a merchant server 129 including a processor 130 and memory 132 including components to facilitate transactions with the user computer system 104 via other entities of the system 100. In some embodiments, the memory 132 may include a transaction communication module 134. The transaction communication module 134 may include instructions to send merchant messages 134A to other entities (i.e., 104, 105, 108, 109, 111) of the system 100 to indicate a transaction has been initiated with the user computer system including payment device data and other data as herein described. The merchant computer system 106 may also include a transaction repository 142 and instructions to store payment and other transaction data 142A within the transaction repository 142. In some embodiments, the merchant computer system 106 may send payment data 143A corresponding to a payment device to the payment network system 108 or other entities of the system 100, or receive payment data 143B from the user computer system 104 in an electronic wallet-based or other computer-based transaction between the user computer system 104 and the merchant computer system 106.

A user computer system 104 may include a processor 145 and memory 146. The user computing system 104 may include a server, a mobile computing device, a smartphone, a tablet computer, a Wi-Fi-enabled device or other personal computing device capable of wireless or wired communication, a thin client, or other known type of computing device. The memory may include various modules including instructions that, when executed by the processor 145 control the functions of the user computer system generally and integrate the user computer system 104 into the system 100 in particular. For example, some modules may include an operating system 150A, a browser module 1508, a communication module 150C, and an electronic wallet module 150D. In some embodiments, the electronic wallet module 150D and its functions described herein may be incorporated as one or more modules of the user computer system 104. In other embodiments, the electronic wallet module 150D and its functions described herein may be incorporated as one or more sub-modules of the payment network system 108.

The payment network system 108 may include a payment server 156 including a processor 158 and memory 160. The memory may include a payment network module 162 including instructions to facilitate payment between parties (e.g., one or more users, merchants, etc.) using the payment system 100. The module 162 may be communicably connected to an account holder data repository 164 including payment network account data 164A. The payment network account data 164A may include any data to facilitate payment and other funds transfers between system entities (i.e., 104, 105, 106, 108, 109, and 111). For example, the payment network account data 164A may include identification data, account history data, payment device data, etc. The module 162 may also include instructions to send payment messages 166 to other entities and components of the system 100 in order to complete transactions between users and/or merchants.

A payment device issuer system 111 may also include a payment device issuer server 170 including a processor 172 and memory 174. The memory may include a payment device issuer module 176 including instructions 182 to facilitate payment to the merchant computer system 106 using the payment system 100. The module 176 may be communicably connected to a clearing data repository 178 including account clearing data 178A. The clearing data 178A may include data to facilitate payment and other funds transfers to/from the merchant. For example, the clearing data 178A may include identification data, account history data, payment device data, etc. The module 176 may also be communicably connected to a cardholder account data repository 180 including cardholder account data 180A. The module 162 may also include instructions to receive payment messages 166 from the payment network system 108 and may include the response data 111 in order to complete transactions between users and/or merchants and better manage user and merchant funds account balances to complete transactions.

An offer server system 109 may also include an offer server 190 including a processor 192 and memory 194. The memory may include an offer module 196 including instructions to facilitate offers to the merchant computer system 106 using the payment system 100. The module 196 may be communicably connected to an offer data repository 198 including offer data 198A. The offer data 198A may include data to facilitate determination and selection of offers to/from the users and merchant. For example, the offer data 198A may include offer identification data, account offer history data, payment device data, etc. The module 196 may also be communicably connected to a cardholder account data repository 200 including cardholder account data 200A. The module 192 may also include instructions to receive payment messages 166 from the payment network system 108.

An offer server 109 may also be designed to execute tasks unique to processing offers. The offer server 109 may execute the offers platform and the offer platform may be designed for analyzing the transaction data 110, determining if the transaction meets an offer and in response to the transaction meeting an offer, executing the offer, creating modified transaction data 111 to reflect the offer and communicating the modified transaction data to at least one of the payment system, the user and the registered merchant. Thus, the offer/response server 109 will require less input output speed than the analysis server 105 but it may still need significant processing power to quickly and accurately make analysis decisions.

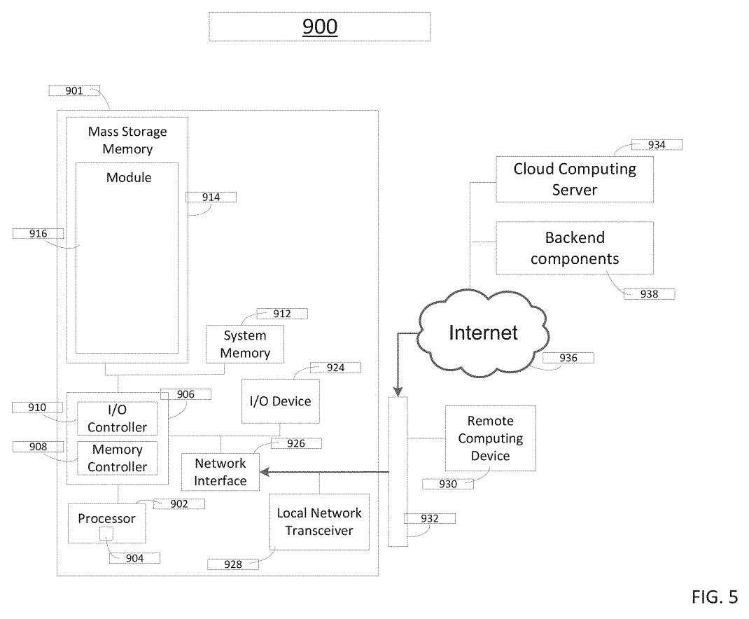

FIG. 5 may be a high-level block diagram of an example computing environment 900 for the system 100 and methods as described herein. The computing device 900 may include a server (e.g., the payment processing server 116, merchant server 129, payment server 156, analysis server 105, offer server 109, mobile computing device (e.g., user computing system 104), a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods described herein may be used to implement and execute the example systems and methods described herein. Although the example system 1000 is described below as including a plurality of peripherals, interfaces, chips, memories, etc., one or more of those elements may be omitted from other example processor systems used to implement and execute the example systems and methods. Also, other components may be added.

As shown in FIG. 5, the computing device 901 includes a processor 902 that is coupled to an interconnection bus. The processor 902 includes a register set or register space 904, which is depicted in FIG. 5 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 5, the computing device 901 may be a multi-processor device and, thus, may include one or more additional processors that are identical or similar to the processor 902 and that are communicatively coupled to the interconnection bus.

The processor 902 of FIG. 5 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein.

The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 5 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 9 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of enrolling an electronic transaction user in an electronic response program without enrollment action by the user comprising:
analyzing bulk electronic transaction data to determine if the transaction is a transaction from a registered merchant in the response program comprising;
selecting the bulk electronic transaction data for a card acceptor identification signal (CAID);
selecting the bulk electronic transaction data for an acquirer business identification number (BIN);
analyzing the selected CAID and BIN to determine if the CAID and BIN belong to a registered merchant;
in response to the CAID and BIN being determined to belong to a registered merchant, communicating the electronic transaction data to an offers platform;
in the offers platform:
analyzing the transaction;
determining if the transaction meets an offer;
in response to the transaction meeting an offer,
executing the offer;
creating modified transaction data to reflect the offer;
communicating the modified transaction data to at least one of:
the payment system,
the user; and
the registered merchant.

2. The method of claim 1, wherein the registered merchant comprises a single registered merchant sales location.

3. The method of claim 1, wherein the CAID and BIN combination represent a single registered merchant sales location.

4. The method of claim 2, wherein the CAID and BIN combination is compared to a lookup table to determine the single registered merchant sales location.

5. The method of claim 1, wherein analyzing the transaction further comprising:
comparing parameters of the transaction to a set of offer rules.

6. The method of claim 1, wherein the offers platform operates according to an offers platform API.

7. The method of claim 1, wherein the CAID and BIN follow a protocol.

8. The method of claim 1, wherein the offers platform API follows an offers platform protocol.

9. The method of claim 1, wherein executing the offer comprises executing at least one of:
a discount;
a rebate;
a free item; and
an increment closer to an additional response.

10. The method of claim 1, further comprising:
presenting a user interface to a merchant;
allowing the merchant to set up response parameters wherein the response parameters comprise at least one of:
time period for the response;
compensation maximum for the response; and
number of repeat response.

11. A system for enrolling an electronic transaction user in an electronic response program without enrollment action by the user comprising:
an analysis server for analyzing bulk electronic transaction data to determine if the transaction is a transaction from a registered merchant in the response program, the analysis server adapted for:
selecting the bulk electronic transaction data for a card acceptor identification signal (CAID);
selecting the bulk electronic transaction data for an acquirer business identification number (BIN);
analyzing the selected CAID and BIN to determine if the CAID and BIN belong to a registered merchant;
in response to the CAID and BIN being determined to belong to a registered merchant, communicating the electronic transaction data to an offers platform on an offer server;
an offer server comprising the offers platform, the offer platform adapted for:
analyzing the transaction;
determining if the transaction meets an offer;
in response to the transaction meeting an offer,
executing the offer;
creating modified transaction data to reflect the offer;
communicating the modified transaction data to at least one of:
the payment system,
the user; and
the registered merchant.

12. The system of claim 1, wherein the registered merchant comprises a single registered merchant sales location.

13. The system of claim 11, wherein the CAID and BIN combination in the analysis server represent a single registered merchant sales location.

14. The system of claim 12, wherein the CAID and BIN combination is compared to a lookup table to determine the single registered merchant sales location.

15. The system of claim 11, wherein analyzing the transaction in the analysis server further comprising:
comparing parameters of the transaction to a set of offer rules.

16. The system of claim 11, wherein the offers platform on the offer server operates according to an offers platform API.

17. The system of claim 11, wherein the CAID and BIN in the analysis server follow a protocol.

18. The system of claim 11, wherein the offers platform API in the offer server follows an offers platform protocol.

19. The system of claim 11, wherein offers platform in the offer server is further adapted for executing the offer comprises executing at least one of:
a discount;
a rebate;
a free item; and
an increment closer to an additional response.

20. The system of claim 11, further comprising:
presenting a user interface to a merchant;
allowing the merchant to set up response parameters wherein the response parameters comprise at least one of:
time period for the response;
compensation maximum for the response; and
number of repeat response.
